(19) United States
(12) Patent Application Publication
(10) Pub. No.: US 2025/0353536 A1
(43) Pub. Date: Nov. 20, 2025

(54) WHEEL BUILT-IN POWER SYSTEM FOR ELECTRIC GOLF BAG TROLLEY

(71) Applicant: TED GOLF EQUIPMENT CO., LTD., Changzhou (CN)

(72) Inventors: Jiaxiong Gong, Changzhou (CN); Qian Gong, Changzhou (CN)

(73) Assignee: TED GOLF EQUIPMENT CO., LTD., Changzhou (CN)

(21) Appl. No.: 18/767,269

(22) Filed: Jul. 9, 2024

(30) Foreign Application Priority Data
May 17, 2024 (CN) 202410616202.2

(51) Int. Cl. B62B 5/00; A63B 55/60; B62B 5/04; F16D 55/02; F16D 121/20; F16D 127/02; F16H 57/02; F16H 57/04; F16H 63/34; H02K 7/116

(52) U.S. Cl. CPC B62B 5/004; A63B 55/60; B62B 5/0066; B62B 5/0457; F16D 55/02; F16H 57/02; F16H 57/0416; F16H 57/0476; F16H 63/345; H02K 7/1166; B62B 2202/406; F16D 2121/20; F16D 2127/02; F16H 2057/02034; F16H 2057/02052; F16H 2057/02056

(57) ABSTRACT

The present disclosure relates to a wheel built-in power system for an electric golf bag trolley, including a motor, and a worm wheel engaged with an output worm of the motor, a spindle of the worm wheel being connected to a hub of any wheel of the electric golf bag trolley. The wheel built-in power system for an electric golf bag trolley of present disclosure is small in size and light in weight, and can be installed in wheels of an electric golf bag trolley, thereby effectively reducing the size of the electric golf bag trolley after being folded, facilitating movement and storage.

### TECHNICAL FIELD OF THE INVENTION

The present disclosure belongs to the technical field of golf bag trolley power systems, and in particular relates to a wheel built-in power system for an electric golf bag trolley.

### BACKGROUND OF THE INVENTION

A golf bag trolley is a transportation device for carrying golf bags during golf, wherein a lithium battery-powered motor-driven electric golf bag trolley can use an electric drive instead of manual labor, making it more convenient and labor-saving to use.

In the existing electric golf bag trolley, a power system is disposed in a trolley body, and the power system is drivingly connected to wheels through connecting rods located on both sides of the trolley body to drive the wheels to rotate. In the power-driven electric golf bag trolley, not only is the power system large in size and heavy in weight, but also the connecting rods and the wheels connected to the connecting rods cannot be folded during a folding process, which directly increases the size of the electric golf bag trolley after being folded, making it very inconvenient to move and store.

In addition, although a hub motor is installed in a wheel to achieve direct driving of the wheel, the hub motor itself does not have a deceleration function, and if the hub motor is applied to the electric golf bag trolley, safety cannot be guaranteed for uneven road conditions such as a golf course.

### SUMMARY OF THE INVENTION

An object of the present disclosure is to provide a wheel built-in power system for an electric golf bag trolley to solve the problem that the electric golf bag trolley is large in size after being folded.

The wheel built-in power system for an electric golf bag trolley of the present disclosure is implemented as follows:
a wheel built-in power system for an electric golf bag trolley includes a motor, and a worm gear engaged with an output worm of the motor, a spindle of the worm gear being connected to a hub of any wheel of the electric golf bag trolley.

Further, the spindle is directly connected to the hub of any wheel of the electric golf bag trolley.

Further, the motor is a brushless motor.

Further, the wheel built-in power system further includes a parking assembly connected to an end of the output worm.

Further, the parking assembly includes a friction plate connected to the output worm, and a brake pad capable of locking the friction plate.

Further, a pin hole is disposed in the output worm, and the friction plate is connected with the output worm through a bolt mounted in the pin hole.

Further, the parking assembly further includes a brake stator, the brake pad is located on an inner side of the brake stator, the friction plate is mounted on one side, facing the brake pad, of the brake stator, and a coil is wound inside the brake stator.

Further, return springs are mounted on one side, facing the brake pad, of the brake stator.

Further, guide pins parallel to the output worm are mounted on the brake stator, and guide notches matched with the guide pins are disposed in an outer ring surface of the brake pad. Further, the worm gear is mounted in a box body.

Further, one end, away from the motor, of the box body is provided with a housing detachably matched with the box body.

Further, a heat-radiating cavity is disposed outside the motor, a plurality of heat-radiating fins are disposed inside the heat-radiating cavity, and heat-radiating windows matched with the heat-radiating cavity are disposed in the box body.

Further, an outer wall, facing away from a corresponding wheel, of the box body is provided with a connection groove.

The present disclosure further provides an electric golf bag trolley, using the wheel built-in power system for an electric golf bag trolley described above.

After adopting the above technical solutions, the present disclosure has the following beneficial effects:
(1) the power system of the present disclosure is small in size and light in weight, can transmit torque to the corresponding wheel by only one-stage transmission, i.e., cooperation of the output worm with the worm wheel, has a simple and compact structure, and has a good transmission effect;
(2) the wheel built-in power system of the present disclosure adopts the cooperative transmission of the worm and the worm wheel, which has little running noise, and has a good deceleration function and self-locking capability, and high safety when in use; and
(3) the wheel built-in power system of the present disclosure can be mounted within wheels of an electric golf bag trolley, torque is directly transmitted to a hub of the wheel without the need for connecting rods for transmission, and then the connecting rods can drive the wheels to be folded on both sides of a trolley body when the electric golf bag trolley is folded, thereby effectively reducing the size and occupied space of the entire golf bag trolley after being folded, making it more convenient to move and store.

### BRIEF DESCRIPTION OF DRAWINGS

The present disclosure will be further described below with reference to the accompanying drawings and embodiments.

FIG. 1 is a structural diagram of a wheel built-in power system for an electric golf bag trolley according to Embodiment 1 of the present disclosure;

FIG. 2 is a structural diagram of the wheel built-in power system for an electric golf bag trolley according to Embodiment 1 of the present disclosure;

FIG. 3 is an exploded schematic view of a motor and a transmission part of the wheel built-in power system for an electric golf bag trolley according to Embodiment 1 of the present disclosure;

FIG. 4 is a schematic diagram showing one way in which the wheel built-in power system for an electric golf bag trolley according to Embodiment 1 of the present disclosure is installed in a wheel;

FIG. 5 is a rear view of a wheel built-in power system for an electric golf bag trolley according to Embodiment 2 of the present disclosure;

FIG. 6 is a cross-sectional view of a portion A-A of FIG. 5;

FIG. 7 is an exploded schematic view of a parking assembly portion of the wheel built-in power system for an electric golf bag trolley according to Embodiment 2 of the present disclosure; and

FIG. 8 is an exploded schematic view of a motor and a box body of a wheel built-in power system for an electric golf bag trolley according to Embodiment 3 of the present disclosure;

In the drawings: motor 1, output worm 2, worm wheel 3, spindle 4, friction plate 5, brake pad 6, pin hole 7, brake stator 8, coil 9, annular cavity 10, annular slot-like bracket 11, mounting cavity 12, wire-passing notch 13, return spring 14, mounting hole I 15, guide pin 16, guide notch 17, mounting hole II 18, box body 19, bearing I 20, side sealing plate 21, housing 22, bearing II 23, heat-radiating cavity 24, heat-radiating window 25, connection groove 26, receiving notch 27, space D.

### DETAILED DESCRIPTION OF THE INVENTION

In order to make the objects, technical solutions and advantages of the embodiments of the present disclosure more clear, the technical solutions in the embodiments of the present disclosure will be clearly and completely described below in conjunction with the accompanying drawings in the embodiments of the present disclosure, and obviously, the described embodiments are some, but not all, embodiments of the present disclosure. Based on the embodiments in the present disclosure, all other embodiments obtained by those of ordinary skill in the art without making inventive steps belong to the scope of protection of the present disclosure.

Thus, the following detailed description of the embodiments of the present disclosure provided in the drawings is not intended to limit the scope of the claimed disclosure, but only to represent selected embodiments of the present disclosure. Based on the embodiments in the present disclosure, all other embodiments obtained by those of ordinary skill in the art without making inventive steps belong to the scope of protection of the present disclosure.

### Embodiment 1

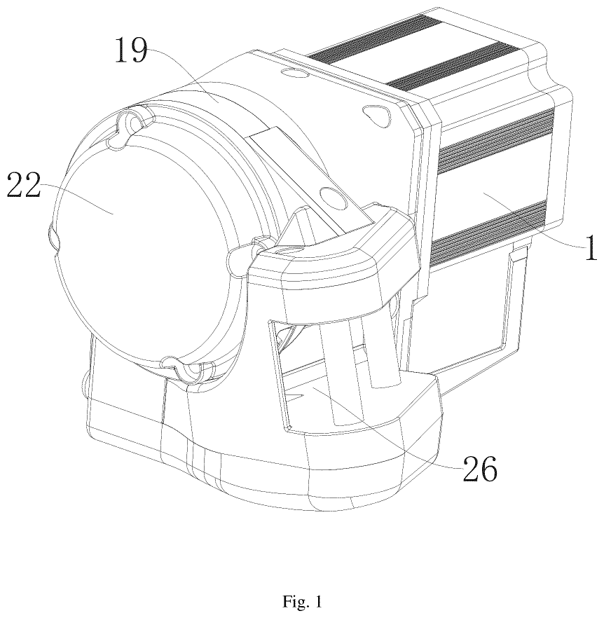

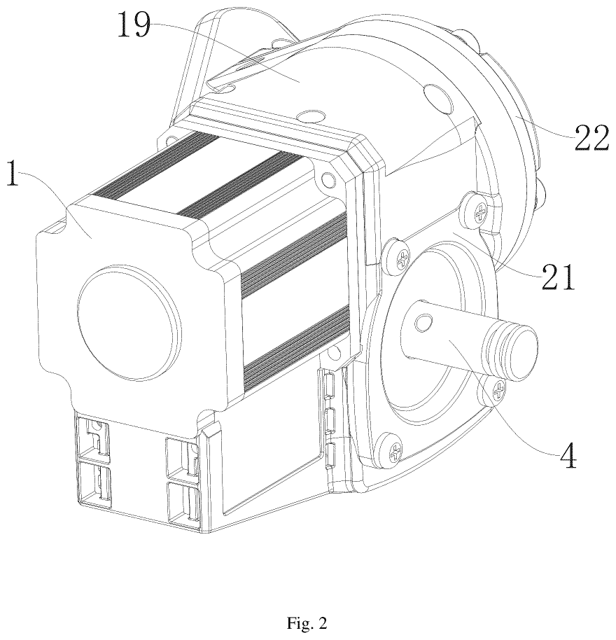

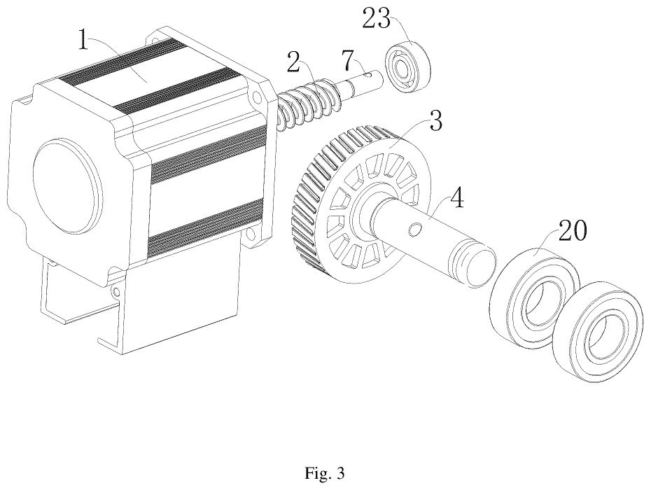

As shown in FIGS. 1 to 4, a wheel built-in power system for an electric golf bag trolley includes a motor 1, and a worm wheel 3 engaged with an output worm 2 of the motor 1, and a spindle 4 of the worm wheel 3 is connected to a hub of any wheel of the electric golf bag trolley.

The spindle 1 is directly connected to the hub of any wheel of the electric golf bag trolley, thereby directly achieving torque transmission.

Although a hub motor can also be installed directly in a wheel, the hub motor itself does not have a deceleration function, and needs to be additionally equipped with a planetary deceleration mechanism, which increases the size and weight of the power system, and the power system also has defects of a small reduction ratio, a high noise, and no self-locking capability.

The wheel built-in power system according to the present disclosure is small in overall size and light in weight, uses the output worm 2 to cooperate with the worm wheel 3, and not only has a small operating noise, but also has a large reduction ratio, i.e., the wheel built-in power system has a good deceleration function, and a driving torque can be increased through deceleration so that the electric golf bag trolley can easily cope with road conditions such as uphill; and at the same time, cooperation of the worm with the worm wheel also has good self-locking capability, which can not only avoid reverse rotation caused by external accidental interference, but also can reduce a braking torque and improve the braking efficiency.

The wheel built-in power system may be installed in any at least one wheel of the electric golf bag trolley.

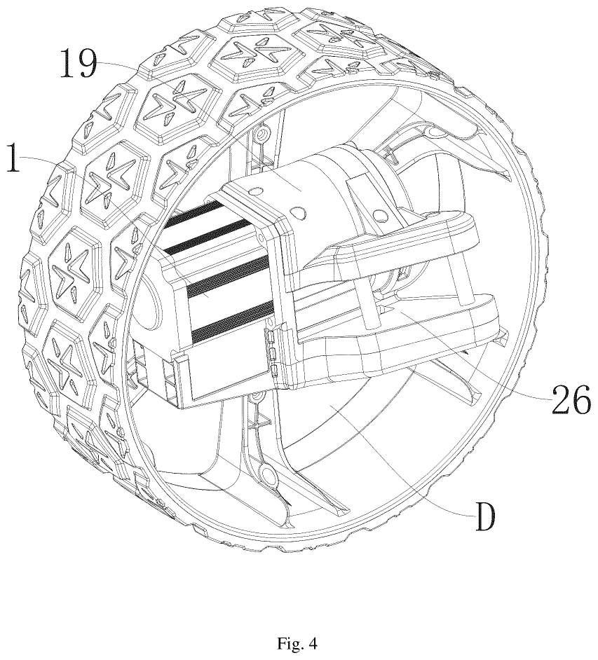

As shown in FIG. 4, the wheel built-in power system, that is, the power system is installed in a space D formed inside the corresponding wheel, but is not limited to the manner in which the power system is completely disposed in the space D, may allow a small portion of the power system to exceed the space D formed in the wheel.

The motor 1 is a brushless motor.

Compared with a brush motor with the same power, the brushless motor employed in the present disclosure is smaller in size, thereby making the structure of the entire wheel built-in power system more compact and more convenient to be housed in a wheel.

In order to be able to protect a transmission part of the worm wheel 3 and the output worm 2, the worm wheel 3 is mounted in a box body 19.

The worm wheel 3 is located inside the box body 19, and the spindle 4 of the worm wheel 3 extends out from one side of the box body 19 and is directly connected to a hub of the corresponding wheel.

And the spindle 4 is matched with the box body 19 through a bearing I 20, and the box body 19 on a side where the bearing I 20 is located is provided with a side sealing plate 21 connected to the box body 19 by bolts, and the side sealing plate 21 is disassembled to facilitate mounting of the worm wheel 3 and the bearing I 20.

A free end of the output worm 2 cooperates with the box body 19 through a bearing II 23 to ensure free rotation of the output worm 2.

In order to facilitate the assembly of the bearing II 23, one end, away from the motor 1, of the box body 19 is provided with a housing 22 detachably matched with the box body 19. In this embodiment, the housing 22 is located at a front end of the box body 19, and the housing 22 and the box body 19 may be connected by bolts.

In this embodiment, the box body 19 includes a cavity for accommodating the worm wheel 3 and the output worm 2, and a support base located on a rear side of the cavity, wherein the motor 1 is mounted on the support base, and the output worm 2 is disposed forward.

In order to achieve the connection between the wheel built-in power system and the body of the electric golf bag trolley, an outer wall, facing away from a corresponding wheel, of the box body 19 is provided with a connection groove 26.

When the wheel built-in power system is installed in a rear wheel of the golf bag trolley, the connection groove 26 is used to be hinged to a connecting rod connecting the trolley body.

If the wheel built-in power system is placed in a front wheel, the connection groove 26 may be not provided, and the box body 19 or the spindle 4 of the worm wheel 3 may be directly rotationally matched with a front wheel frame.

### Embodiment 2

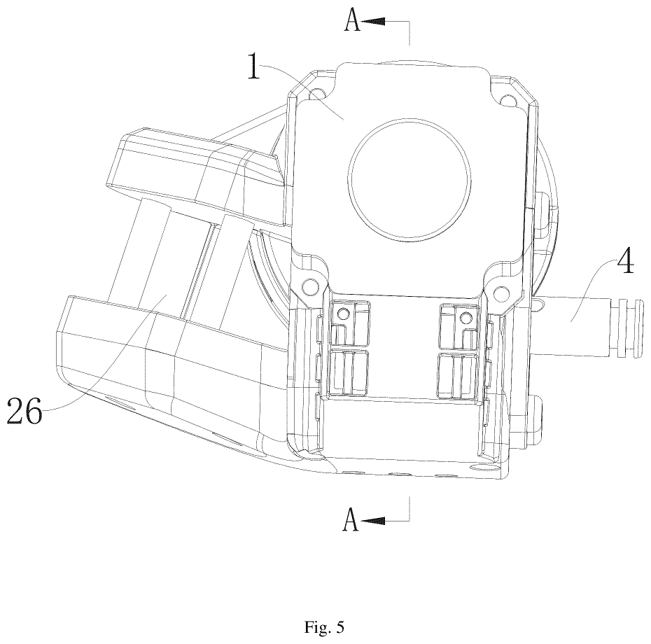

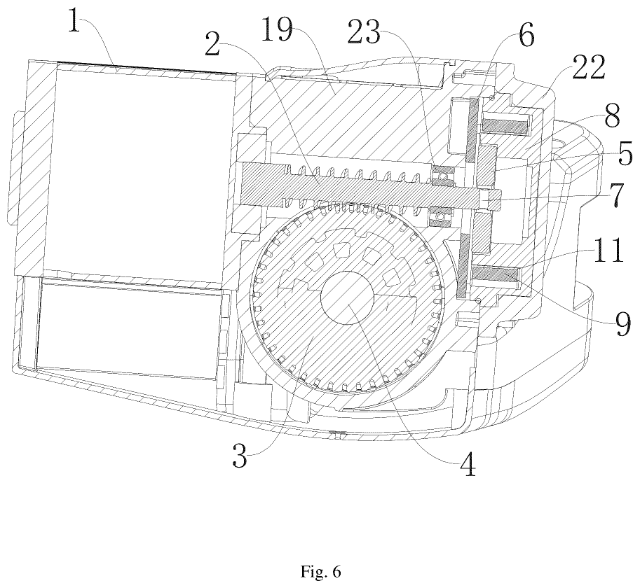

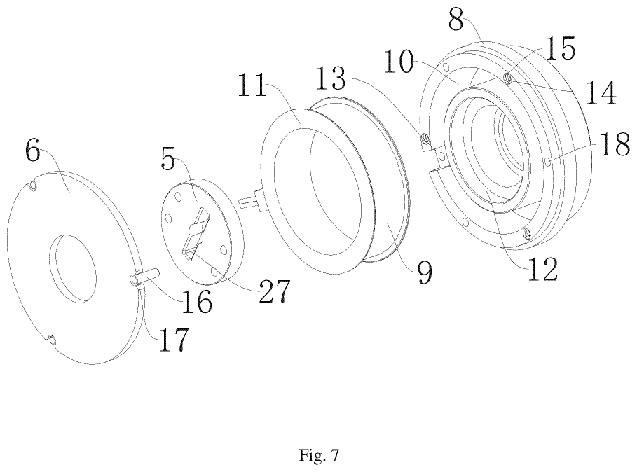

As shown in FIGS. 5 to 7, on the basis of Embodiment 1, this embodiment further provides a wheel built-in power system for an electric golf bag trolley, and a structure of the wheel built-in power system is substantially the same as that in Embodiment 1 except that:

in order to improve the parking function of the wheel built-in power system and ensure safety when the electric golf bag trolley is parked, the wheel built-in power system further includes a parking assembly connected to an end of the output worm 2.

In order to be able to achieve the parking effect, the parking assembly includes a friction plate 5 connected to the output worm 2, and a brake pad 6 capable of locking the friction plate 5.

The output worm 2 can drive the friction plate 5 to synchronously rotate when the electric golf bag trolley is running. When the electric golf bag trolley is parked, the brake pad 6 moves toward the friction plate 5 and can lock the friction plate 5 to prevent the friction plate 5 from rotating, so that the output worm 2 cannot rotate, and the purpose of parking is achieved.

In order to achieve the connection of the output worm 2 with the friction plate 5, a pin hole 7 is disposed in the output worm 2, and the friction plate 5 is connected with the output worm 2 through a bolt (not shown in the figures) mounted in the pin hole 7.

In particular, an outer periphery of an inner hole of the friction plate 5 is provided with two receiving notches 27 communicating with the friction plate 5 and symmetrically arranged, and when the output worm 2 equipped with the bolt is fitted in the inner hole of the friction plate 5, both ends of the bolt are located in the two receiving notches 27, and when the output worm 2 is rotated, the friction plate 5 can be driven to rotate synchronously by the bolt.

In order to be able to drive the brake pad 6 so that the brake pad 6 locks the friction plate 5, the parking assembly further includes a brake stator 8, the brake pad 6 is located on an inner side of the brake stator 8, the friction plate 5 is mounted on one side, facing the brake pad 6, of the brake stator 8, and a coil 9 is wound inside the brake stator 8.

In particular, the brake stator 8 is provided with an annular cavity 10, the annular cavity 10 is provided with an annular slot-like bracket 11 with an opening facing outward, and the coil 9 is wound inside the annular slot-like bracket 11.

One end, facing the brake pad 6, of an inner hole of the brake stator 8 is provided with a mounting cavity 12 having an inner diameter larger than the inner hole, and the friction plate 5 is placed in the mounting cavity 12.

When the coil 9 is energized, the brake stator 8 becomes a magnet with a magnetic force, which attracts the brake pad 6, thereby clamping the friction plate 5 between the brake pad 6 and the brake stator 8, preventing rotation of the friction plate 5 and the output worm 2.

Preferably, an outer ring surface of the brake stator 8 is provided with a wire-passing notch 13, which facilitates the end of coil 9 to be led out and connected to a power supply.

In order to achieve inward displacement reset of the brake pad 6 when the parking is released, return springs 14 are mounted on one side, facing the brake pad 6, of the brake stator 8.

In particular, the side, facing the brake pad 6, of the brake stator 8 is provided with mounting holes I 15 in which the return springs 14 are placed.

When the coil 9 is energized, and the brake pad 6 moves towards the brake stator 8 and clamps the friction plate 5, the return springs 14 will be compressed. When the coil 9 is de-energized, the brake stator 8 loses the magnetic force, and the brake pad 6 moves inwardly, that is, moves away from the brake stator 8 to reset under the action of the elastic force of the return springs 14, thereby releasing the parking state.

In order to guide the movement of the brake pad 6, guide pins 16 parallel to the output worm 2 are mounted on the brake stator 8, and guide notches 17 matched with the guide pins 16 are disposed in an outer ring surface of the brake pad 6.

Specifically, one side, facing the brake pad 6, of the brake stator 8 is provided with mounting holes II 18 in which the guide pins 16 are mounted, and the guide pins 16 can guide the brake pad 6 during parking or releasing the parking state, i.e. when the brake pad 6 moves.

At the same time, the guide pins 16 can also limit the brake pad 6 in the circumferential direction, avoiding the brake pad 6 from freely rotating along with the friction plate 5, etc.

In this embodiment, the parking assembly is disposed at one end, facing away from the motor 1, of the box body 19, i.e., a front end of a cavity of the box body 19. The output worm 2 cooperates with the worm wheel 3 and is connected to the box body 19 through the bearing II 23. The end, facing away from the motor 1, of the output worm 2, i.e., a front end of the output worm 2, is connected to the parking assembly, i.e., connected to the friction plate 5 after passing through the brake pad 6.

When the parking assembly is matched with the motor 1, the parking assembly is installed by disassembling the housing 22 which can provide good protection for the parking assembly.

The parking assembly is not limited to being mounted at the front end of the output worm 2, but can also be mounted at a tail of the motor 1 so as to cooperate with a rear end of the output worm 2, likewise enabling a parking effect.

### Embodiment 3

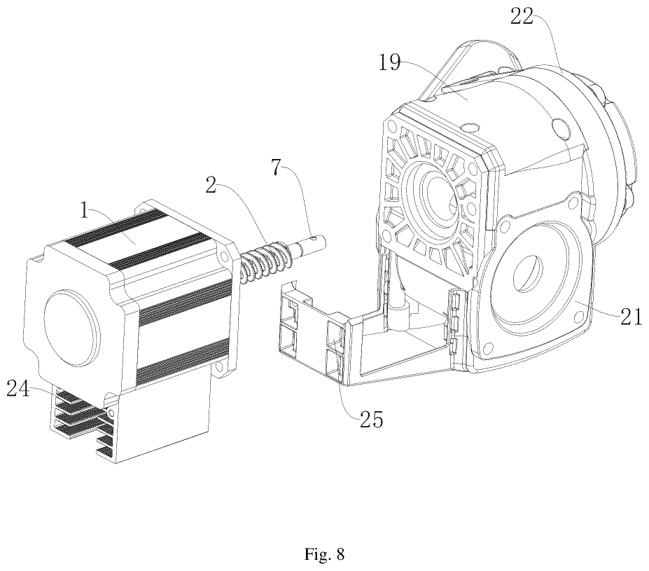

As shown in FIG. 8, on the basis of Embodiment 2, this embodiment further provides a wheel built-in power system for an electric golf bag trolley, and a structure of the wheel built-in power system is substantially the same as that in Embodiment 2 except that:

A heat-radiating cavity 24 is disposed outside the motor 1, a plurality of heat-radiating fins are disposed inside the heat-radiating cavity 24, and heat-radiating windows 25 matched with the heat-radiating cavity 24 are disposed in the box body 19.

The heat-radiating windows 25 are located in a rear wall of the support base of the box body 19 so as to be matched with the heat-radiating cavity 24 at the bottom of the motor 1 to improve the heat dissipating effect of the motor 1 to ensure normal operation of the motor 1.

The wheel built-in power system according to the present disclosure has a simple and compact overall structure, small size, and light weight, and can be installed in any wheel of an electric golf bag trolley, and can solve the problems that the electric golf bag trolley is heavy in weight and large in size after being folded, so that the electric golf bag trolley can be moved and placed more easily.

The wheel built-in power system is within the scope to be protected by the present disclosure whether it has a parking assembly or not, regardless of whether the wheel built-in power system is provided with the heat-radiating cavity 21, and regardless of its shape and specification.

### Embodiment 4

This embodiment provides an electric golf bag trolley, using the wheel built-in power system for an electric golf bag trolley disclosed in any of the above embodiments.

The electric golf bag trolley includes various electric golf bag trolleys, and may be, but is not limited to, a two-wheeled golf bag trolley, a three-wheeled golf bag trolley, a four-wheeled golf bag trolley, or a four-wheeled manned golf bag trolley. The wheel built-in power system may be adjusted in shape or specification according to the type and size of the electric golf bag trolley.

The above are merely preferred embodiments of the present disclosure, and any manner in which a power system is installed in a wheel of an electric golf bag trolley is within the protection scope of the present disclosure.

1. A wheel built-in power system for an electric golf bag trolley, comprising a motor, and a worm wheel engaged with an output worm of the motor, a spindle of the worm wheel being connected to a hub of any wheel of the electric golf bag trolley.

2. The wheel built-in power system for an electric golf bag trolley according to claim 1, wherein the spindle is directly connected to the hub of any wheel of the electric golf bag trolley.

3. The wheel built-in power system for an electric golf bag trolley according to claim 1, wherein the motor is a brushless motor.

4. The wheel built-in power system for an electric golf bag trolley according to claim 1, further comprising a parking assembly connected to an end of the output worm.

5. The wheel built-in power system for an electric golf bag trolley according to claim 4, wherein the parking assembly comprises a friction plate connected to the output worm, and a brake pad capable of locking the friction plate.

6. The wheel built-in power system for an electric golf bag trolley according to claim 5, wherein a pin hole is disposed in the output worm, and the friction plate is connected with the output worm through a bolt mounted in the pin hole.

7. The wheel built-in power system for an electric golf bag trolley according to claim 5, wherein the parking assembly further comprises a brake stator, the brake pad is located on an inner side of the brake stator, the friction plate is mounted on one side, facing the brake pad, of the brake stator, and a coil is wound inside the brake stator.

8. The wheel built-in power system for an electric golf bag trolley according to claim 7, wherein return springs are mounted on one side, facing the brake pad, of the brake stator.

9. The wheel built-in power system for an electric golf bag trolley according to claim 7, wherein guide pins parallel to the output worm are mounted on the brake stator, and guide notches matched with the guide pins are disposed in an outer ring surface of the brake pad.

10. The wheel built-in power system for an electric golf bag trolley according to claim 1, wherein the worm wheel is mounted in a box body.

11. The wheel built-in power system for an electric golf bag trolley according to claim 10, wherein one end, away from the motor, of the box body is provided with a housing detachably connected with the box body.

12. The wheel built-in power system for an electric golf bag trolley according to claim 10, wherein a heat-radiating cavity is disposed outside the motor, a plurality of heat-radiating fins are disposed inside the heat-radiating cavity, and heat-radiating windows matched with the heat-radiating cavity are disposed in the box body.

13. The wheel built-in power system for an electric golf bag trolley according to claim 10, wherein an outer wall, facing away from a corresponding wheel, of the box body is provided with a connection groove.

14. An electric golf bag trolley, using the wheel built-in power system for an electric golf bag trolley according to claim 1.
